(19) United States
(12) Patent Application Publication
(10) Pub. No.: US 2011/0269486 A1
(43) Pub. Date: Nov. 3, 2011

(54) NOTICE METHOD AND ASSISTANCE SYSTEM FOR SENDING E-MAIL

(75) Inventors: Johnny Chen, Santa Ana, CA (US); Gary Kung, Santa Ana, CA (US); Balusek Roland, Santa Ana, CA (US); Musa Ibrahim Kakish, Santa Ana, CA (US)

(73) Assignee: I/O INTERCONNECT, LTD., Santa Ana, CA (US)

(21) Appl. No.: 13/076,918

(22) Filed: Mar. 31, 2011

Related U.S. Application Data
(60) Provisional application No. 61/329,446, filed on Apr. 29, 2010.

(51) Int. Cl. H04W 4/12; G06F 15/16

(52) U.S. Cl. 455/466; 709/206

(57) ABSTRACT

A notice method for e-mail is provided by the present invention. The notice method of the present invention first checks whether or not a user sends an e-mail to a recipient. When the notice method checks that the user sends the e-mail, a notice message is sent to the recipient's phone from the user's phone for noticing the recipient that the user already sends the e-mail.

### CROSS-REFERENCE TO RELATED APPLICATIONS

The application claims priority of U.S. provisional patent application Ser. No. 61/329,446 filed on Apr. 29, 2010, the contents of which are hereby incorporated by reference.

### FIELD OF THE INVENTION

The present invention relates to a notice mechanism, and more particularly to a notice mechanism for sending e-mail.

### BACKGROUND OF THE INVENTION

FIG. 1A is a schematic diagram for sending an e-mail from a user to a recipient according to one prior art. Referring to FIG. 1A, when a user 102 wants to send an e-mail to the recipient 104, the user 102 can operate an e-mail software 106, which is installed into a computer 108, to send the e-mail to the recipient's e-mail box 110 through a network 112, such as a internet or a local network.

FIG. 1B is a schematic diagram for sending an e-mail from a user to a recipient according to another prior art. Referring to FIG. 1B, in this case, the user 102 also can use the computer 108 to log in an e-mail website 120 through the network 112. Then, the user 102 can operate the computer 108 to control the e-mail website 120 to send the e-mail to the recipient's e-mail box 110.

No matter what way the recipient 104 chooses for receiving the e-mail from the user 102, the recipient 104 has to open the e-mail box 110, and thereby the recipient 104 knows that the user 102 sends the e-mail. However, not everyone is used to check the e-mail box anytime. Most of people are used to check the e-mail box at a specific time, such as working time. Except the specific time, these people rarely open the e-ail box. Therefore, if the information of the e-mail is very urgent, the recipient is difficult to read the e-mail immediately.

### SUMMARY OF THE INVENTION

Therefore, the present invention is to provide a notice method for e-mail, for noticing a recipient who gets an e-mail sent from a user immediately.

In addition, the present invention is to provide an assistance system for assisting a user to send an e-mail to a recipient smoothly, and the recipient gets the delivery information related to the e-mail immediately.

A notice method for e-mail is provided by the present invention. The notice method of the present invention first checks whether or not a user sends an e-mail to a recipient. When the notice method checks that the user sends the e-mail, a notice message is sent to the recipient's phone from the user's phone for noticing the recipient that the user already sends the e-mail.

In some embodiments of the present invention, the notice method further provides a first control application program and a second control application program. Wherein, the first control application is used for installing into the user's phone and controlling the user's phone to send the notice message, when the users sends the e-mail to the recipient. Furthermore, the second control application program is used for installing into the user's computer.

From another viewpoint, an assistance system for sending e-mail is provided by the present invention. The assistance system of the present invention is suitable for a user's computer and mobile device with a message process module. The assistance system has a first control means which is configured into the user's phone, and coupled to the message process module for controlling the message process module to send a notice message to a recipient's mobile device, when the user sends the e-mail to the recipient.

In some embodiments of the present invention, the assistance system further has a second control means, which links with the first means. In addition, the second control means is configured into the user's computer for monitoring the internal instructions of the user's computer to check whether or not the user uses an e-mail software installed into the user's computer to send the e-mail to the recipient.

Since the present invention can notice the recipient an e-mail already delivered from the user, the recipient can read the coming e-mail immediately.

In some embodiments of the present invention, the assistance system further has a data transmission interface for linking the first control means and the second control means. In other embodiments, the assistance system comprises a server for linking to the first control means and the second control means respectively.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1A is a schematic diagram for sending an e-mail from a user to a recipient according to one prior art.

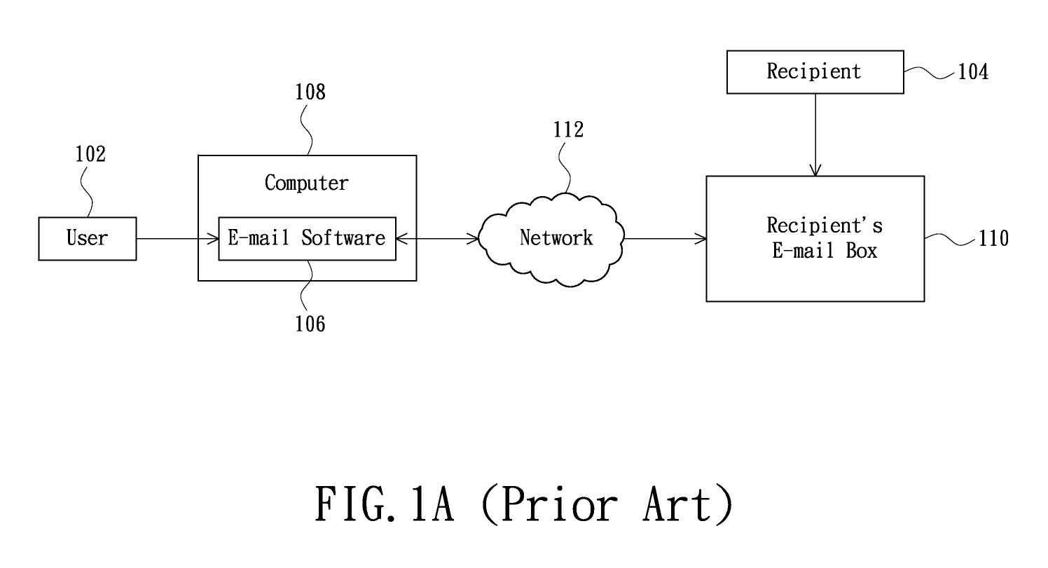

FIG. 1B is a schematic diagram for sending an e-mail from a user to a recipient according to another prior art.

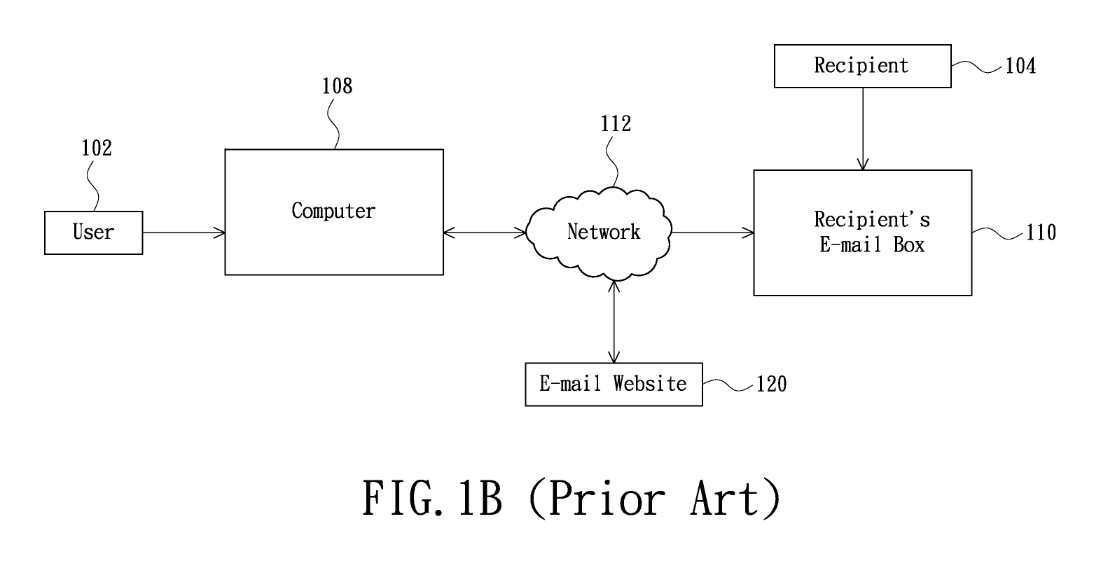

FIG. 2 is a schematic diagram of an assistance system for sending e-mail according to a first embodiment of the present invention.

FIG. 3 is a flow chart of sending notice message to recipient according to one preferred embodiment of the present invention.

FIG. 4 is a schematic diagram of an assistance system for sending e-mail according to a second embodiment of the present invention.

FIG. 5 is a block diagram of a data transmission interface according to one embodiment of the present invention.

FIG. 6 is a schematic diagram of an assistance system for sending e-mail according to a third embodiment of the present invention.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

The main scope of the present invention is that making the user's mobile device sends a notice message to a recipient. Wherein the notice message is about that the user already sends an e-mail to the recipient. Therefore, the recipient can know the e-mail has been delivered immediately. In order to implement the above method, an assistance system is provided for sending the e-mail as following description:

### Embodiment 1 for Assistance System of the Present Invention

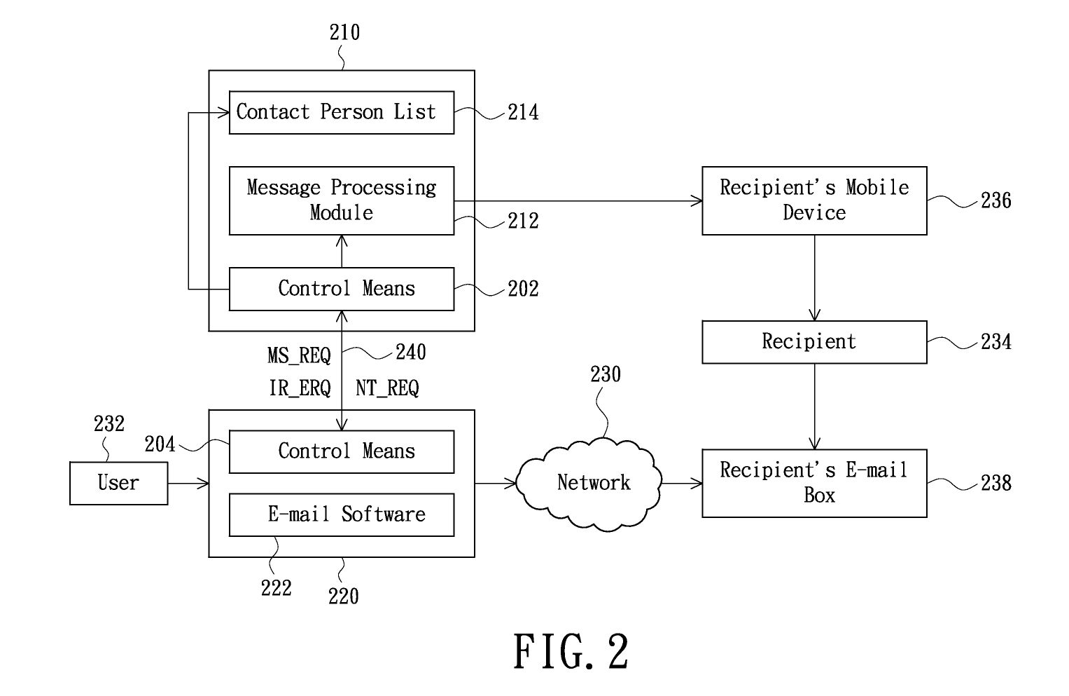

FIG. 2 is a schematic diagram of an assistance system for sending e-mail according to a first embodiment of the present invention. Referring to FIG. 2, the assistance system of this embodiment has a control means 202, which is configured into a user's mobile device 210. Wherein, the user's mobile device 210 is probably a smart phone, which has a message processing module 212 used for sending or receiving a message, such as SMS message or MMS message. In addition, the control means 202 is implemented by an application program.

Furthermore, the assistance system of this embodiment further comprises a control means 204, which is configured into a user's computer 220. Wherein, the computer 220 is probably a desktop computer, a notebook computer, or a tablet computer. In addition, an e-mail software 222 is installed into the user's computer 220. In this embodiment, the control means 204 can monitor the internal instructions of the user' s computer 204 for checking that whether a user 232 uses the e-mail software 222 to send the e-mail to the recipient's e-mail box 238 through a network 230, such as internet or a local network.

When the control means 204 checks that the user 232 uses the e-mail software 222 to send the e-mail to the recipient's e-mail box 238 through the network 230, the control means 204 would send a message sent request MS_REQ, such as SMS message or MMS message, to the control means 202. In this embodiment, the user's mobile device 210 links to the user's computer 204 through a data transmission interface 240. Therefore, the message sent request MS_REQ is sent to the control means 202 through the data transmission interface 240. Meanwhile, the control means 202 controls the message processing module 212 to send a notice message to a recipient's mobile device, such as a smart phone or normal cell phone, for noticing a recipient 234 that the user 232 already sends the e-mail. Wherein, the content of the notice message can be purely noticing recipient to reads the e-mail, showing the title of the e-mail, showing the content of the e-mail, or showing a portion of content of the e-mail, such as head-line of the e-mail.

Since the recipient's mobile device 236 is usually body carrying, the recipient 234 can obtain the information about the e-mail being already delivered immediately. Meanwhile, the recipient 234 can link to the recipient's e-mail box 238, such like using the mobile device 236 to link to the e-mail box 238 to read the e-mail.

### The Steps of Sending Notice Message to the Recipient

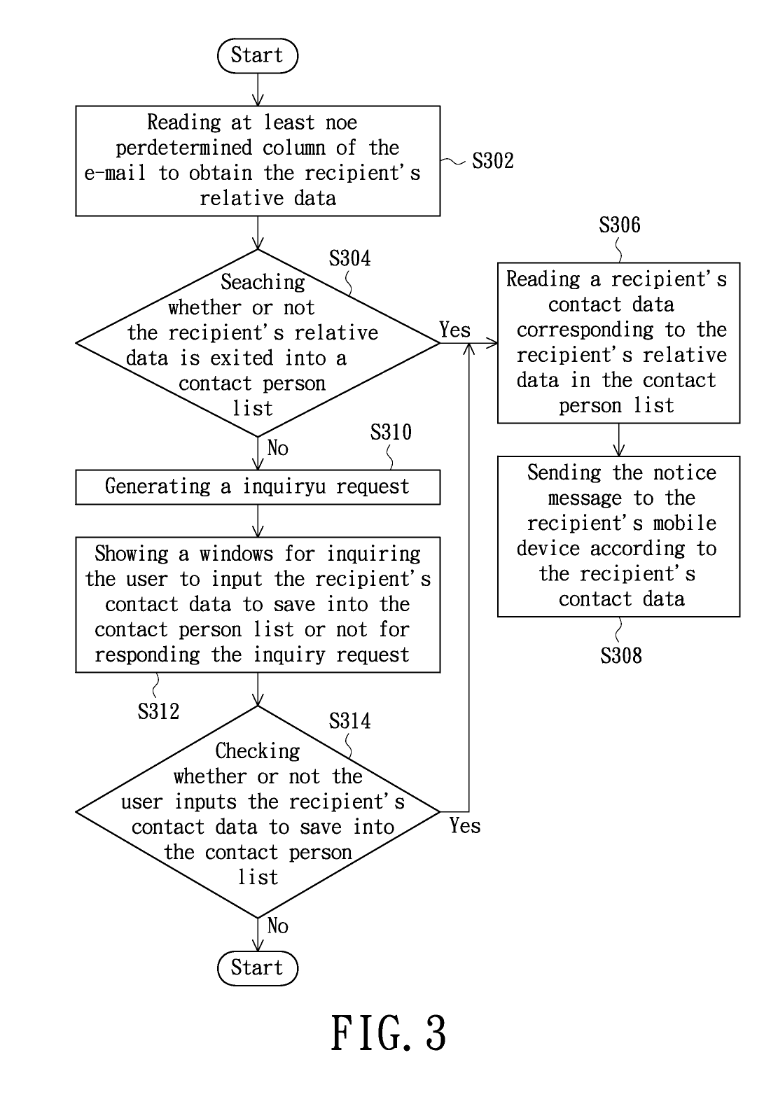

FIG. 3 is a flow chart of sending notice message to recipient according to one preferred embodiment of the present invention. Referring to FIGS. 2 and 3 together, when the control means 204 sends the message sending request MS_REQ to the control means 202 through the data transmission interface 240, the control means 202 would read at least one predetermined column of the e-mail sent, such as name column to the recipient, e-mail address column, or phone number column, to obtain a recipient's relative data, as description in the step S302. When the control means 202 obtains the recipient's relative data, such like the recipient's name, the control means 202 would perform the step S304 to search whether or not the recipient's relative data is exited into a contact person list 214, which is saved into the user's mobile device 210.

When the control means 202 finds the recipient's relative data already being exited into the contact person list (i.e. “Yes” labeled on the step S304), the control means 202 would read a recipient's contact data corresponding to the recipient's relative data in the contact person list 214 as description in the step S306. Then, the control means 202 controls the message processing module 212 to perform the step S308 to send the notice message to the recipient's mobile device according to the recipient's contact data for responding the message sending request MS_REQ.

Contrarily, if the control means 202 doesn't find the recipient's relative data in the contact person list 214 (i.e. “No” labeled on the step S304), the control means 202 would perform the step S310 to send a inquiry request IR_REQ to the control means 204 through the data transmission interface 240. Meanwhile, the control means 204 would show a window on the user's computer 220 for inquiring the user 232 to input the recipient's contact to save into the contact person list 214 or not for responding the inquiry request IR_REQ as description in the step S312. Then, the control means 204 checks whether or not the user 232 input the recipient's contact data. If the control means 204 checks that the user 232 inputs the recipient's contact data (i.e. “Yes” labeled on the step S314), the control means 204 would send the recipient's contact data input by the user 232 to the control means 202 to save into the contact person list 214. Therefore, the control means 202 can carry out the steps S306 and S308.

### Embodiment 2 for Assistance System of the Present Invention

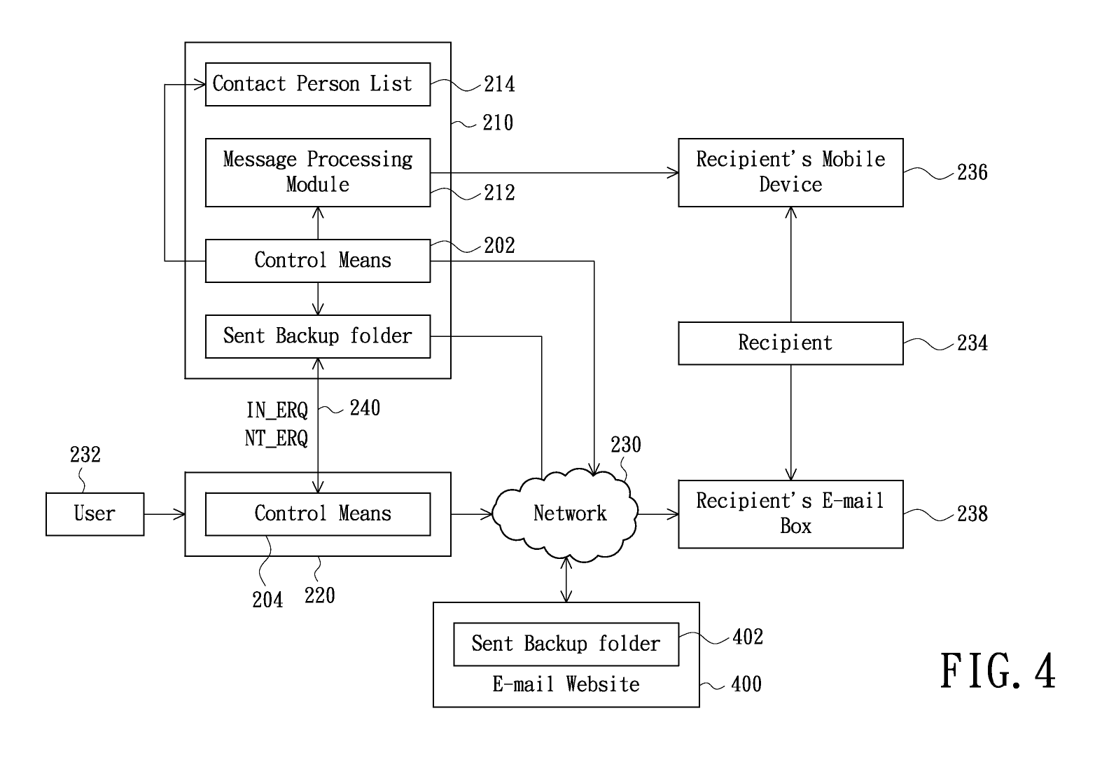

FIG. 4 is a schematic diagram of an assistance system for sending e-mail according to a second embodiment of the present invention. Referring to FIG. 4, the structure of the assistance system in this embodiment is similar with the structure shown in FIG. 2. However, the user 232 can operate the computer 220 to link to an e-mail website 400 through the network 230 for sending the e-mail to the recipient's e-mail box 238. Therefore, the control means 202 would link to the website 400 for synchronizing the sent backup folder 412 with the sent backup folder 402.

It is generally known that when the user 232 uses the e-mail website 400 to send the e-mail, the sent e-mail is backup copied into the sent backup folder 402. Since the sent backup folder 412 is synchronized with the sent backup folder 402, the backup of the sent e-mail, which is saved in the sent backup folder 402, is also exited in the sent backup folder 412. Therefore, in this embodiment, the control means 202 would monitor the sent backup folder 412 as a predetermined time passing to check whether a new backup of the sent e-mail is exited in the sent backup folder 412. When the control means 202 checks that a new backup of the sent e-mail is exited in the sent backup folder 412, the control means 202 would read at least one predetermined column of the backup of the sent e-mail for obtaining the recipient's relative data.

Similarly, the control means 202 can obtain the recipient's contact data according to the recipient's relative data, and control the message processing module 212 sending the notice message to the recipient mobile device 236. The detail description of sending the notice message to the recipient's mobile device 236 is shown in FIG. 3, one who ordinarily skilled in the art can refer above description of FIG. 3 by self.

### Data Transmission Interface

Referring to FIGS. 2 and 4, in the first and second embodiment, the user's mobile device 210 can link to the user's computer 220 directly through the data transmission 240. In some embodiments, the data transmission 240 is probably a wireless data transmission interface, such like Bluetooth transmission interface, infrared transmission interface, WiFi network, 3G mobile network, 4G mobile network, or other wireless network. Of course, in other embodiments, the data transmission interface 240 is also wire transmission interface, such like USB interface.

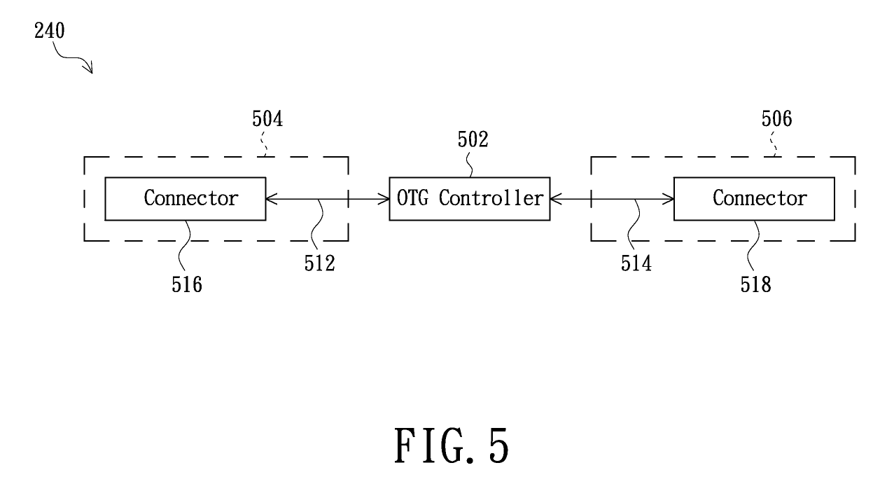

FIG. 5 is a block diagram of a data transmission interface according to one embodiment of the present invention. Referring to FIG. 5, the data transmission interface 240 comprises an OTG controller 502, connection modules 504 and 506. Wherein, the OTG controller 502 is coupled to the connection modules 504 and 506. In this embodiment, the connection module 504 can connects to the user's mobile device, such as mobile device 210 in FIG. 2 or 4, through a first connection protocol. Similarly, the connection module 506 can connect to the user's computer, such as computer 220, through a second connection protocol. In some embodiments, the first connection protocol is the same with the second connection protocol, such like USB interface. In other embodiments, the first connection protocol is different from the second connection protocol.

In this embodiment, the connection modules 504 and 506 has transmission lines 512 and 514, and connector 516 and 518 respectively. The transmission line 512 couples the OTG controller 502 to the connector 516. In addition, the transmission 514 couples the OTG controller 502 to connector 518. When the connector 516 is inserted into a connection port of the user's mobile device, and the connector 518 is inserted into a connection port of the user's computer, the OTG controller 502 sets the user's computer being a master, and sets the user's mobile device being a slave.

### Embodiment 3 for Assistance System of the Present Invention

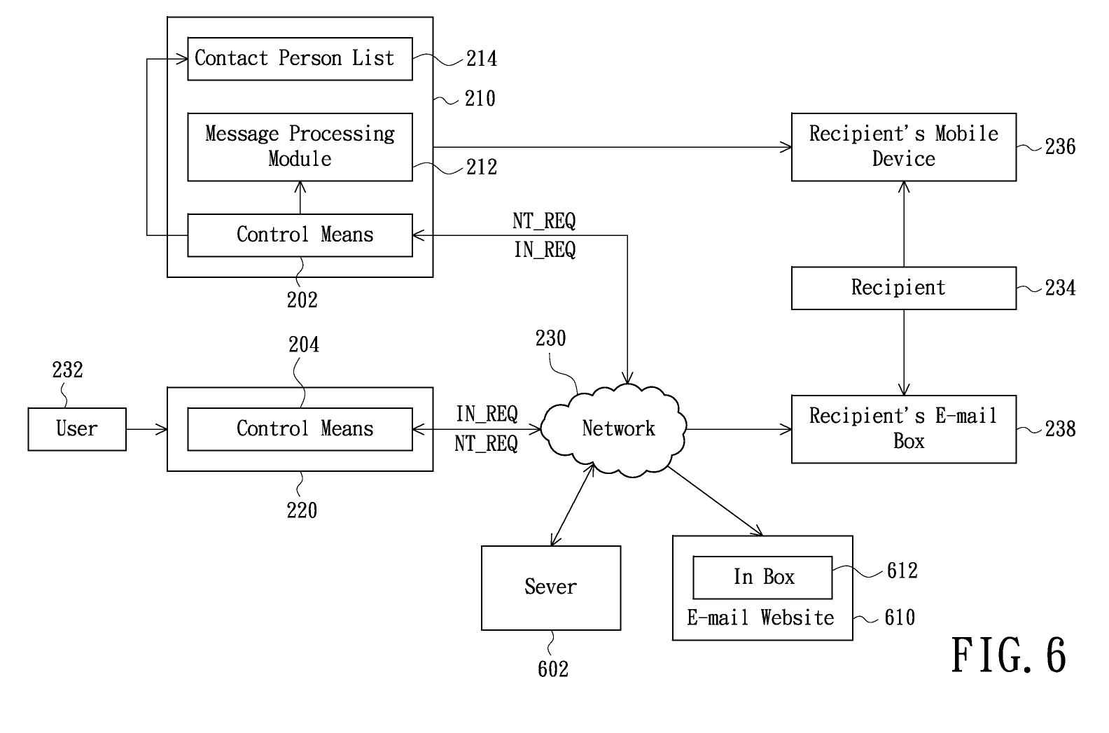

FIG. 6 is a schematic diagram of an assistance system for sending e-mail according to a third embodiment of the present invention. Referring to FIG. 6, in this embodiment, the user's mobile device 210 cannot link to the user's computer 220 directly. Therefore, in this embodiment, a server 602 is configured for linking the mobile device 210 and the computer 220 respectively through the network 230. When the control means 202 and 204 has require to exchange information by each other, such as sending inquiry message IN_REQ, the information is transmitted through the server 602.

The assistance system of this embodiment further allows the user 232 using the server 602 to send the e-mail to the recipient's e-mail box 238. When the user 232 uses the server 602 to send the e-mail to the recipient's box, the server 602 would send a copy of the sent e-mail to an inbox 612 of an e-mail website 610. In particularly, the copy has a specific format. Therefore, in this embodiment, the control means 202 needs to link to the e-mail website 610 through the network 230 as a predetermined time passing for checking whether or not the inbox 612 has a new copy with the specific format. When the control means 202 checks that a new copy with the specific format is exited in the inbox 612, the control means 202 would read at least one predetermined column of the copy with the specific format for obtaining the recipient's relative data.

Similarly, the control means 202 can obtain the recipient's contact data according to the recipient's relative data, and control the message processing module 212 sending the notice message to the recipient mobile device 236. The detail description of sending the notice message to the recipient's mobile device 236 is shown in FIG. 3, one who ordinarily skilled in the art can refer above description of FIG. 3 by self.

### Transfer Notice Function

Referring to the FIG. 2, 4 or 6, in some embodiments, the control means 202 and 204 further has a transfer notice function. In such embodiments, when the control means 202 checks that user's mobile device 210 receives a coming message, such like SMS message, MMS message, or e-mail, etc., the control means 202 would generate a notice request NT_REQ. In the first and second embodiments, the notice request NT_REQ is sent to the control means 204 through the data transmission interface 240. However, in the third embodiment, the notice request NT_REQ is sent to the server 602 through the network 230. Then, the server 602 sends the notice request NT_REQ to the control means 204 through the network 230.

When the control means 204 receives the notice request NT_REQ, the control means 204 controls the computer 220 generating an alarm message. In some embodiments, the step of generating the alarm message is that a voice message is generated for reading out the content of the coming message, or reading out the classification of the coming message as the coming message being the e-mail with attachment file. In other embodiments, the step of generating the alarm comprises generating flash light, alarm sound. Further more, the notice message can be a notice text information and notice window on the computer 204 for showing the content of the coming message. Therefore, the user 232 can know the content of the coming message without switching the mobile device 210 and the computer 220.

### SUMMARY

In summary, the present invention would send a notice message to recipient as the user sending an e-mail to the recipient for noticing the recipient that the e-mail is already delivered. Therefore, the recipient can read the e-mail faster. In addition, due to the control means installed in the user's mobile device and computer have the transfer notice function, it is making both of the user and the recipient can work more immediately.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A notice method for e-mail, comprising:
checking whether or not a user sends an e-mail to a recipient; and
sending a notice message to the recipient's phone from the user's phone for noticing the recipient that the user already sends the e-mail.

2. The notice method according to claim 1, further comprising:
providing a first control application program for installing into the user's phone and controlling the user's phone to send the notice message, when the users sends the e-mail to the recipient; and
providing a second control application program for installing into the user's computer.

3. The notice method according to claim 2, wherein the step of checking whether or not a user sends the e-mail to a recipient comprises making the second control application program to monitor whether or not the user uses an e-mail software to send e-mail, wherein the e-mail software is installed into the user's computer.

4. The notice method according to claim 3, further comprising:
making the second control application program generating a message sending request, when the second application program checks that the users uses the e-mail software to send the e-mail to the recipient;
making the second control application program to read a content of at least one predetermined column in the e-mail for obtaining the recipient's relative data;
making the first control application program searching whether or not the recipient's relative data is exited into a contact list saved in the user's phone;
making the first control application program controlling the user's phone to send the notice message to the recipient's phone according to a recipient's contact data corresponding to the recipient's relative data in the contact person list for responding the message sending request, when the recipient's relative data is exited into the contact list; and
making the second control application program generating an inquiry window on the user's computer for inquiring the user inputting the recipient's contact data to save into the contact person list or not, when the recipient's data isn't exited into the contact person list.

5. The notice method according to claim 2, wherein the step of checking whether or not a user sends the e-mail to a recipient comprises:
making the first control application program linking to an e-mail website;
making the first control application program synchronizing a sent backup folder of the website and a sent backup folder of the user's phone; and
making the first control application program to check whether or not a new backup of the sent e-mail, which is the e-mail sent to the recipient from the user, is in the sent backup folder of the user's phone, when a predetermined time passes.

6. The notice method according to claim 5, further comprising:
making the first control application program to read a content of at least one predetermined column in the new backup of the sent e-mail for obtaining the recipient's relative data, when the first control application program checks that the sent backup folder of the user's phone has the new backup of the sent e-mail;
making the first control application program searching whether or not the recipient's relative data is exited into a contact list saved in the user's phone;
making the first control application program controlling the user's phone to send the notice message to the recipient's phone according to a recipient's contact data corresponding to the recipient's relative data in the user's phone for responding the message sending request, when the recipient's relative data is exited into the contact list; and
making the second control application program generating an inquiry window on the user's computer for inquiring the user inputting the recipient's contact data to save into the contact person list or not for responding to an inquiry request from the first control application program, when the recipient's data isn't exited into the contact person list.

7. The notice method according to claim 2, further comprising:
configuring a server to link to the first control application program and the second control application program respectively; and
making the server sending a copy of the e-mail to an inbox of an e-mail as the user using the server sending the e-mail to the recipient, wherein the copy has a specific format.

8. The notice method according to claim 7, wherein the step of checking whether or not a user sends the e-mail to a recipient comprises:
making the first control application program linking to the e-mail website, when a predetermined time passes; and
making the first control application program checking whether or not the inbox has a new copy with the specific format.

9. The notice method according to claim 8, further comprising:
making the first control application program to read a content of at least one predetermined column in the new copy with the specific format for obtaining the recipient's relative data, when the first control application program checks that the inbox has the new copy with the specific format;
making the first control application program searching whether or not the recipient's relative data is exited into a contact list saved in the user's phone;
making the first control application program controlling the user's phone to send the notice message to the recipient's phone according to a recipient's contact data corresponding to the recipient's relative data in the user's phone for responding the message sending request, when the recipient's relative data is exited into the contact list; and
making the second control application program generating an inquiry window on the user's computer for inquiring the user inputting the recipient's contact data to save into the contact person list or not for responding to an inquiry request from the first control application program, when the recipient's data isn't exited into the contact person list.

10. The notice method according to claim 2, further comprising:
generating a notice request from the first control application program, when the user's phone receives a coming message; and
making the second control application program controlling the user's computer to generate an alarm message to notice the user.

11. The notice method according to claim 10, wherein the coming message is SMS message, MMS message, or e-mail.

12. The notice method according to claim 10, wherein the step of generating the alarm message comprises generating voice message for reading out the content or the classification of the coming message, flash light, alarm sound, notice text information and notice window.

13. The notice method according to claim 1, wherein the notice message is SMS message or MMS message.

14. An assistance system for sending e-mail, suitable for a user's computer and mobile device with a message process module, comprises:
a first control means, configured into the user's phone, and coupled to the message process module for controlling the message process module to send a notice message to a recipient's mobile device.

15. The assistance system according to claim 14, further comprising:
a second control means, linking with the first means, and being configured into the user's computer for monitoring the internal instructions of the user's computer to check whether or not the user uses an e-mail software installed into the user's computer to send the e-mail to the recipient.

16. The assistance system according to claim 14, further comprises a data transmission interface links the first control means and the second control means.

17. The assistance system according to claim 16, wherein the data transmission interface is a wireless transmission interface.

18. The assistance system according to claim 16, wherein the data transmission comprises:
a first connection module, used for connecting to the user's phone through a first connection protocol;
a second connection module, used for connecting to the user's computer through a second connection protocol; and
an OTG controller, coupling to the first and second connection modules, for setting the user's computer being a master and the user's mobile device being a slave.

19. The assistance system according to claim 18, the first connection protocol is the same with the second connection protocol.

20. The assistance system according to claim 19, the first connection protocol is USB protocol.

21. The assistance system according to claim 18, the first connection protocol is different from the second connection protocol.

22. The assistance system according to claim 12, further comprising a server, linking with the first and second control means respectively.

23. The assistance system according to claim 11, the user's mobile device is a smart phone.

24. The assistance system according to claim 11, the user's computer is one of a desktop computer, a notebook computer, and a tablet computer.
